(19) United States
(12) Patent Application Publication
(10) Pub. No.: US 2017/0177776 A1
(43) Pub. Date: Jun. 22, 2017

(54) PARTITIONING OF WIRING FOR CAPACITANCE EXTRACTION WITHOUT LOSS IN ACCURACY

(71) Applicant: International Business Machines Corporation, Armonk, NY (US)

(72) Inventors: Lewis W. Dewey, III, Wappingers Falls, NY (US); Ronald D. Rose, Essex Junction, VT (US); David J. Widiger, Pflugerville, TX (US)

(21) Appl. No.: 14/970,745

(22) Filed: Dec. 16, 2015

(51) Int. Cl. G06F 17/50

(52) U.S. Cl. CPC G06F 17/5072; G06F 17/5081

(57) ABSTRACT

Aspects of the present invention include a method, system and computer program product. The method includes identifying an overall shape as part of a design of circuitry of an integrated circuit or a semiconductor chip, and partitioning the overall shape into a plurality of sub-shapes. The method also includes performing a capacitance extraction for each sub-shape, each sub-shape including the sub-shape itself and at least one portion of at least one adjacent sub-shape, wherein the performing a capacitance extraction determines an amount of capacitance for each sub-shape. The method further includes combining the determined amount of capacitance for each sub-shape into a total determined amount of capacitance for the overall shape.

### BACKGROUND

The present invention relates to the design of integrated circuits, and more specifically to a method, system, and computer program product for accurately predicting or extracting the capacitive coupling of circuit wiring on an integrated circuit or semiconductor chip during its design, to therefore accurately predict the speed of the designed circuitry on the integrated circuit or chip.

For analysis of performance of electronic circuits on or within semiconductor chips or integrated circuits (“ICs”), it is desirable to accurately predict the speed of the circuits during the design phase. To accurately predict the speed or performance of the circuits, it is desirable to accurately simulate the electronic elements of the circuits and extract or predict the amount of undesirable capacitance coupling of the circuitry, in particular that of the interconnect circuit wiring.

There are numerous approaches within the field of IC or semiconductor chip design to predicting, or extracting, the capacitive coupling of the circuitry, with some approaches being fast and relatively not very accurate, and others approaches being slower but with relatively greater accuracy. The multitude of approaches allows a circuit designer to perform an initial speed analysis of the circuitry relatively quickly using the less accurate methods, and focus on the problematic circuits afterwards with a relatively more accurate but slower approach. In the latter area, the relatively most accurate approaches are generally based on some type of direct solution of Poisson's equation.

A typical approach is to include all the shapes of a net as well as all shapes sufficiently close to each of the net's shapes at once in a field solver solution for the capacitance extraction problem. In other words, this approach involves extracting or predicting the capacitance of an entire shape at once. While this approach yields relatively highly accurate results, nets with numerous or lengthy shapes are inherently relatively complex, and therefore require a prohibitive amount of processing and, thus, cost, to achieve any usable results.

On the other hand, another typical approach to capacitance extraction is to partition a set of shapes into several sub-shapes by selectively splitting or partitioning the shapes, for example, with intersecting planes, or using similar types of partitioning rules. Each partition or sub-shape is analyzed with a field solver and the results are typically joined together. However, this approach suffers from errors near where the partition boundaries occur, since the shapes of the adjoining partitions are usually not taken into account. This error can be mitigated by increasing the partition size, but doing so increases the complexity of the problem presented to the field solver.

Another approach to the capacitive extraction problem involves, rather than focusing on a particular net, extracting a group of shapes within a region, the shapes possibly representing portions of several nets. After extraction of a sufficient number of regions, the desired result may be obtained. However, this approach suffers as well from errors in the vicinity of where the partitions are made.

Thus, what is needed is a method, system, and computer program product of capacitive extraction or prediction involving improved shape partitioning and processing, thereby resulting in improved accuracy and performance in the overall IC or chip design process.

### SUMMARY

According to an embodiment of the present invention, a method includes identifying an overall shape as part of a design of circuitry of an integrated circuit or a semiconductor chip, and partitioning the overall shape into a plurality of sub-shapes. The method also includes performing a capacitance extraction for each sub-shape, each sub-shape including the sub-shape itself and at least one portion of at least one adjacent sub-shape, wherein the performing a capacitance extraction determines an amount of capacitance for each sub-shape. The method further includes combining the determined amount of capacitance for each sub-shape into a total determined amount of capacitance for the overall shape.

According to another embodiment of the present invention, a system includes a processor in communication with one or more types of memory, the processor configured to identify an overall shape as part of a design of circuitry of an integrated circuit or a semiconductor chip, and partition the overall shape into a plurality of sub-shapes. The processor is also configured to perform a capacitance extraction for each sub-shape, each sub-shape including the sub-shape itself and at least one portion of at least one adjacent sub-shape, wherein the processor being configured to perform a capacitance extraction by determining an amount of capacitance for each sub-shape. The processor is further configured to combine the determined amount of capacitance for each sub-shape into a total determined amount of capacitance for the overall shape.

According to yet another embodiment of the present invention, a computer program product includes a non-transitory storage medium readable by a processing circuit and storing instructions for execution by the processing circuit for performing a method that includes identifying an overall shape as part of a design of circuitry of an integrated circuit or a semiconductor chip, and partitioning the overall shape into a plurality of sub-shapes. The method also includes performing a capacitance extraction for each sub-shape, each sub-shape including the sub-shape itself and at least one portion of at least one adjacent sub-shape, wherein the performing a capacitance extraction determines an amount of capacitance for each sub-shape. The method further includes combining the determined amount of capacitance for each sub-shape into a total determined amount of capacitance for the overall shape.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a top view of a wiring portion of an integrated circuit in which the capacitance of a shape of a wiring portion is to be extracted in accordance with an embodiment of the present invention;

FIG. 5 is a top view of the wiring portion of the integrated circuit of FIG. 4 in which a region is considered for analysis for extracting or predicting the capacitance of a smaller segment of the shape in accordance with an embodiment of the present invention;

FIG. 6 illustrates a number of shapes utilized in the capacitive extraction method, system, and computer program product of embodiments of the present invention;

FIG. 7 illustrates a number of shapes spaced apart as utilized in the capacitive extraction method, system, and computer program product of embodiments of the present invention;

FIG. 8 is a flow diagram of steps in a method for capacitive extraction in accordance with an embodiment of the present invention; and

FIG. 9 illustrates an alternative within the method of FIG. 8 that identifies certain shapes and does not ignore the extracted capacitance to those shapes in accordance with an embodiment of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

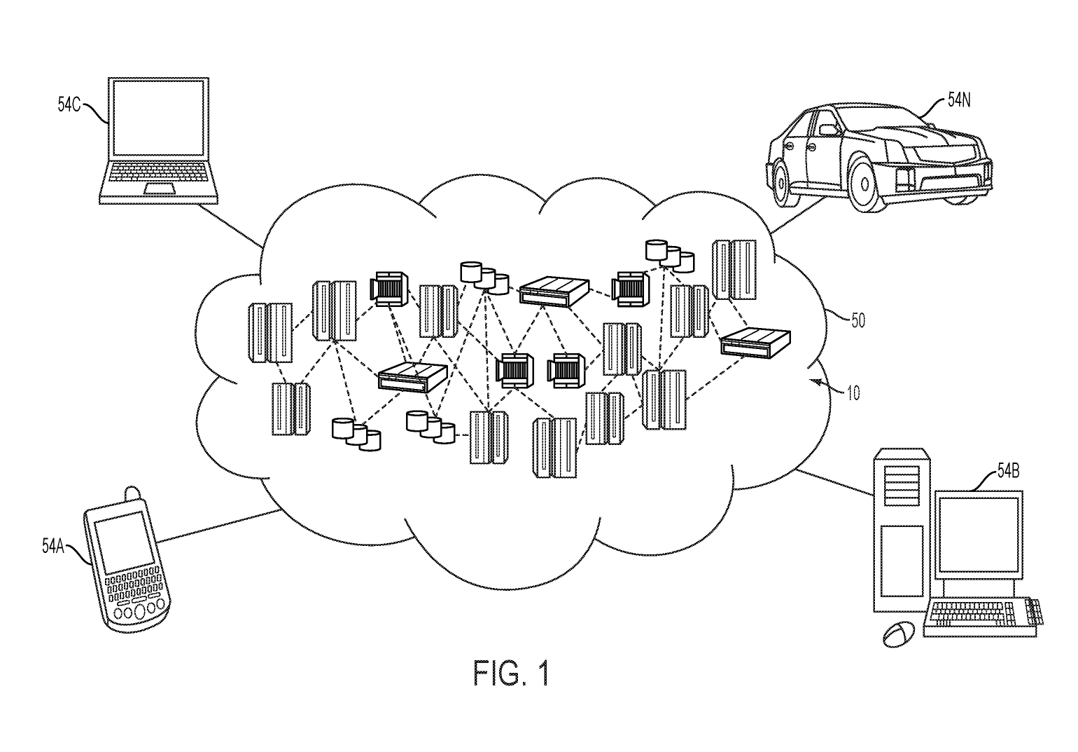

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

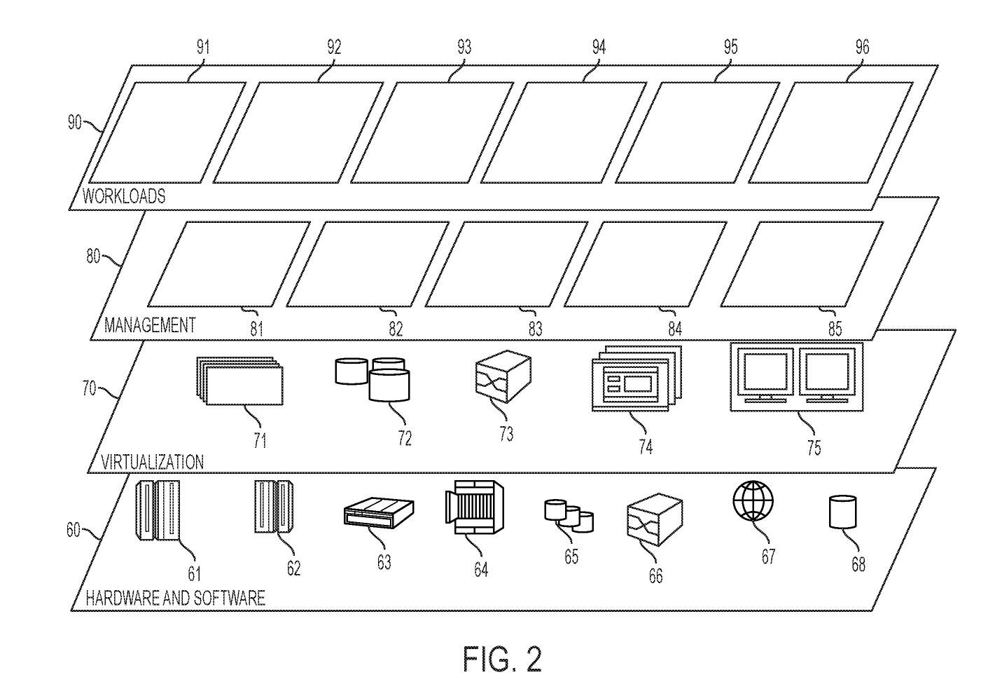

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for accurately predicting or extracting the capacitive coupling of circuit wiring on an integrated circuit or semiconductor chip during its design, to therefore accurately predict the speed of the designed circuitry on the integrated circuit or chip.

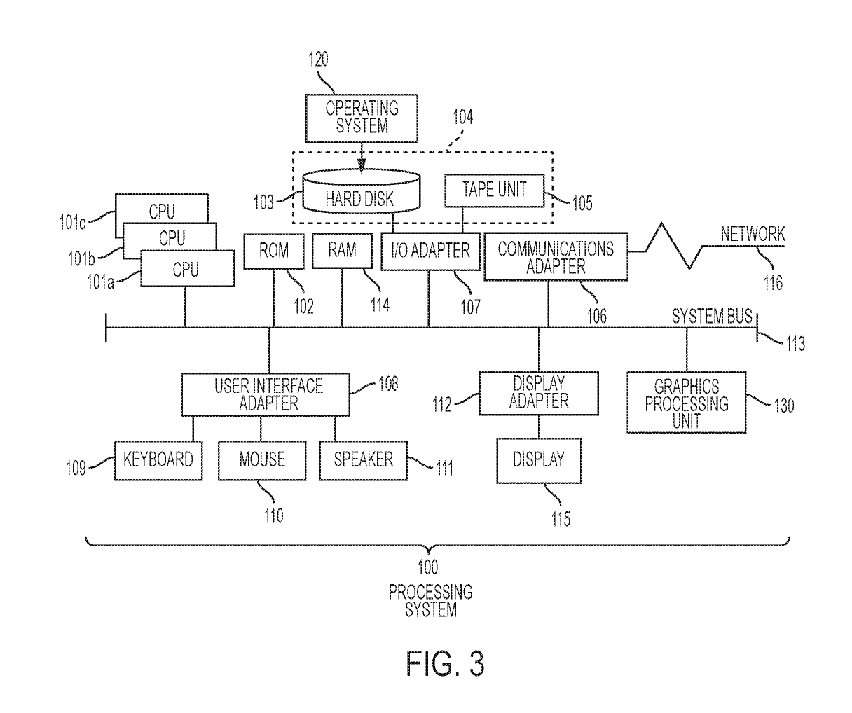

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with exemplary embodiments of the disclosure, methods, systems, and computer program products are disclosed for accurately predicting or extracting the capacitive coupling of circuit wiring on an integrated circuit or semiconductor chip during its design, to therefore accurately predict the speed of the designed circuitry on the integrated circuit or chip.

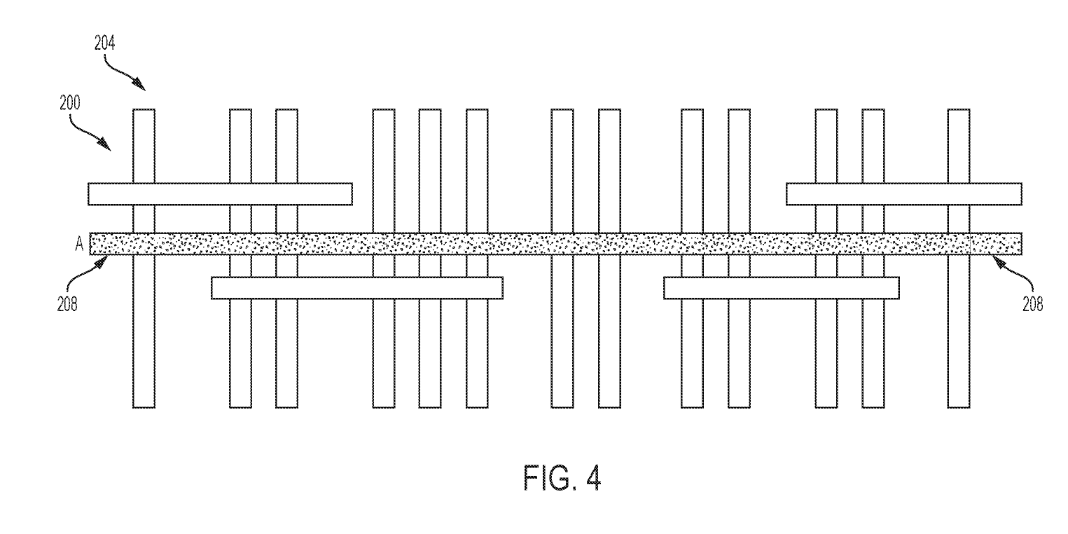

With reference now to FIG. 4, there illustrated is a top view of an exemplary interconnect wiring portion 200 of an integrated circuit (“IC”) or semiconductor chip 204 (both collectively referred to herein as an “IC”) in which the capacitance of a particular wiring shape “A” 208 of the wiring portion 200 is to be extracted in accordance with an embodiment of the present invention. Here, for exemplary purposes, wiring shape A 208 is shown as a rectangle. However, it is to be understood that wiring shape A can be any shape in accordance with embodiments of the present invention in light of the teachings herein.

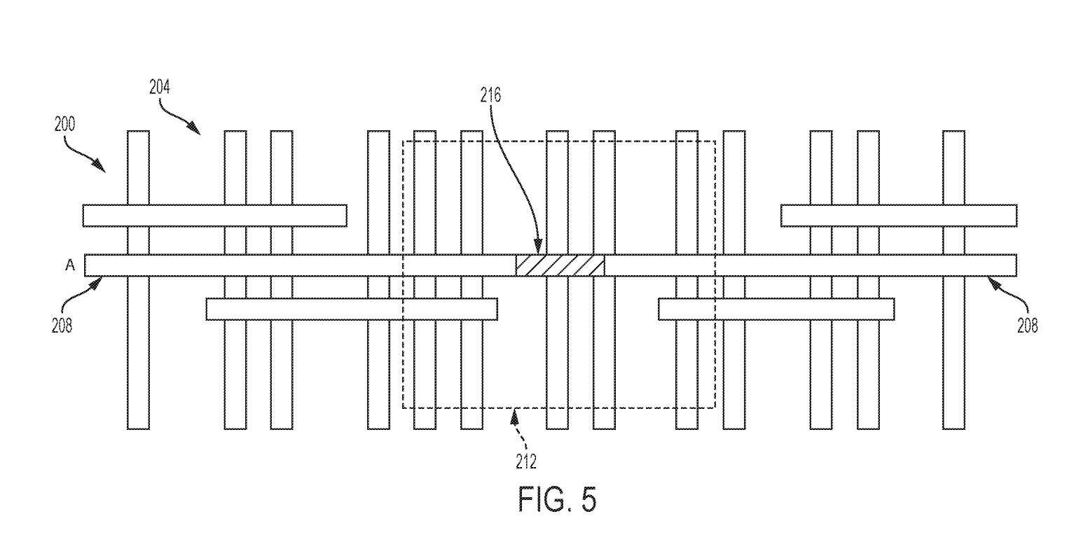

Referring to FIG. 5, there illustrated is a top view of the interconnect wiring portion 200 of the integrated circuit 204 of FIG. 4 in which a selected region 212 of the wiring portion 200 may be considered for analysis for extracting or predicting the capacitance of a smaller segment 216 of shape “A” 208, in accordance with an embodiment of the present invention. By considering a smaller partition or segment (e.g., “sub-shape”) 216 of the overall shape A 208 together with the remainder of shape A 208, the resulting capacitance extraction of the small segment 216 of shape A 208 is relatively more accurate, as described hereinafter.

In accordance with embodiments of the present invention, shape A 208 can be divided or partitioned into many smaller segments or sub-shapes 216. Each smaller segment 216 may be analyzed separately for capacitance extraction, with the total extraction expense being considerably less than if done for the entire shape A 208 at once, yet retaining full accuracy. Using a state-of-the-art field solver, splitting or partitioning a relatively long shape A 208 into ten smaller segments or sub-shapes 216, for example, in accordance with an embodiment of the present invention, results in a total speedup for the overall capacitance extraction field solver, for example, by a factor of three and reduced memory needs by a factor of ten. It also allows for relatively increased parallelism during field solver execution.

In accordance with embodiments of the present invention, a capacitance extraction or prediction problem can be partitioned with essentially no loss in accuracy. By doing so, relatively complex capacitance extraction problems can be greatly simplified. Also, essentially unlimited accuracy can be applied in a partitioned manner, thereby avoiding the expense of large partitions and the inaccuracy of smaller partitions. The partitioning process according to embodiments of the present invention allows for the extraction of capacitance information from a circuit without any loss in accuracy, even for the most exact solution methods. This is done by extracting the capacitance for each sub-shape or partition of a larger overall shape, as part of a net of shapes, and then adding together the individual capacitances of the sub-shapes to arrive at the predicted or extracted capacitance of the overall shape (e.g., shape A 208 in FIG. 5).

For each smaller “target” sub-shape or shape partition, any nearby or adjacent (not necessarily touching or in contact with the target sub-shape) and within a predetermined distance from the target sub-shape may be included in the analysis in accordance with an embodiment of the present invention. This type of “intelligent partitioning” also includes shapes belonging to the same net as the target shape. Then, only capacitances involving the target shape or shape partition may be extracted. In particular, the capacitance of shapes of the same net as the target shape or shape partition may be ignored. Then, the capacitance results are combined for each net. There is no loss in accuracy with this approach of embodiments of the present invention for even finely-partitioned shapes of the net under analysis. Also, the method of embodiments of the present invention ignores any capacitive coupling from a net to itself which is normally acceptable.

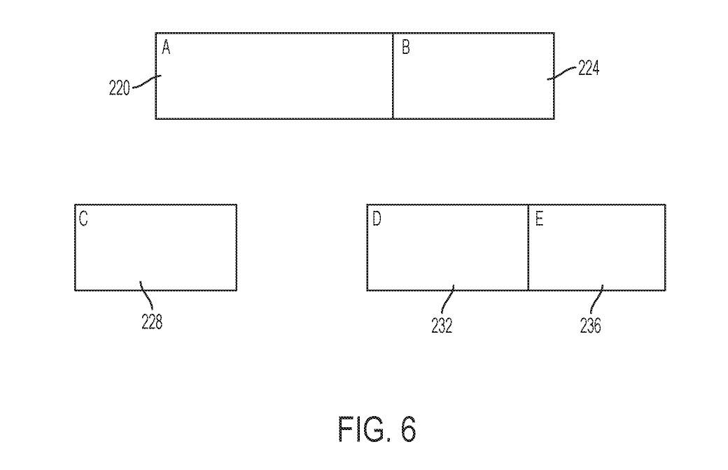

In the interest of demonstrating why there is no loss in accuracy in the proposed process, we refer to FIG. 6, in an exemplary embodiment of the present invention, consider two touching target shapes A 220 and B 224 as shown. The target shapes A 220 and B 224 shown are coupled to shapes C 228, D 232, and E 236, wherein shapes D 232 and E 236 are touching while shape C 228 is not touching any of the other shapes shown in FIG. 6.

Next, consider two extractions: one extraction where the capacitances to shapes A 220 and B 224 are extracted separately, and another extraction where the capacitances are extracted together. The extraction process of embodiments sets the target shape or shapes at some voltage or potential that is different from that of the other shapes. The amount of electrical charge induced on each shape, divided by the potential difference, is the capacitance from the target to that shape. The target shape or shapes may be set to, for example, 1 volt and the other shapes to, for example, 0 volts, regardless of whether or not they are touching the target shape or shapes and/or any other shape.

In FIG. 6 the shape A 220 is first set to 1 volt and the others shapes, including shape B 224, are set to zero volts. The induced electrical charge on each shape set at zero volts is then determined by solving Poisson's equation in any one of known ways, using the defined potential on each shape as the boundary conditions from the following equation.

$${∇}^{2} {φ}_{A} = \frac{{ρ}_{A}}{ɛ ( r )}$$

The charges on shapes C 228, D 232, and E 236 due to shape A 220 being set to 1 volt are determined as Q_{CA}, Q_{DA}, and Q_{EA}. The charge induced on shape B 224 is ignored, according to the method disclosed here in accordance with embodiments of the present invention. Indeed, the charge induced on shape B 224 would be undefined since shapes A 220 and B 224 are in contact with one another. That is, the capacitance of shapes of the same net as the target shape or shape partition may be ignored, wherein shape B 224 may be of the same net as shape A 220 or shape B 224 may be of the same shape partition as shape A 220.

In a similar way, shape B 224 is set to 1 volt and the remaining shapes, including shape A 220, are set to zero volts. Poisson's equation is again solved.

$${∇}^{2} {φ}_{B} = \frac{{ρ}_{B}}{ɛ ( r )}$$

The charges on shapes C 228, D 232, and E 236 due to shape B 224 being set to 1 volt are determined as Q_{CB}, Q_{DB}, and Q_{EB}. The charge induced on shape A 220 is ignored, according to the method disclosed here in accordance with embodiments of the present invention.

Now, shapes A 220 and B 224 are both set to 1 volt, and the charges on shapes C 228, D 232, and E 236 are determined by solving Poisson's equation:

$${∇}^{2} {φ}_{AB} = \frac{{ρ}_{AB}}{ɛ ( r )}$$

The charges on shapes C 228, D 232, and E 236 due to both shape A 220 and shape B 224 being set to 1 volt are determined as Q_{CAB}, Q_{DAB}, and Q_{EAB}.

Next, the resulting charges for the case where both shape A 220 and shape B 224 are set to 1 volt may be shown to be the same as the sum of the charges for the cases where shape A 220 and shape B 224 are individually set to 1 volt. This results simply from the fact that Poisson's equation is linear.

The sum of the potential fields for the cases where shape A 220 and shape B 224 are individually set to 1 volt can be shown to be the potential field for the case where both shape A 220 and shape B 224 are set to 1 volt by observing that such a field obeys Poisson's equation and that the potential boundary conditions are correct. That is, the sum of the two individual potentials yields 1 volt on both shapes A 220 and B 224. Then:

$${∇}^{2} {φ}_{AB} = {∇}^{2} ( {φ}_{A} + {φ}_{B} ) = {∇}^{2} {φ}_{A} + {∇}^{2} {φ}_{B} = \frac{{ρ}_{A}}{ɛ ( r )} + \frac{{ρ}_{B}}{ɛ ( r )} ≡ \frac{{ρ}_{AB}}{ɛ ( r )}$$

Thus, the charges on shapes C 228, D 232, and E 236 are seen to be the sum of the charges for the case where shape A 220 and shape 224 B are individually set to 1 volt.

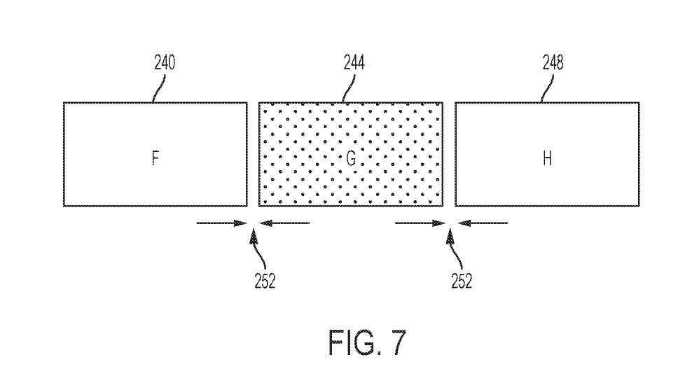

Referring to FIG. 7, to better understand why a capacitive analysis can be performed with touching shapes at different potentials, a case may be constructed where the touching shapes F 240, G 244, H 248 are separated from the shape being analyzed by a relatively small amount or distance 252, and limiting that space to zero. The capacitance between the two shapes will limit to infinity, but according to embodiments of the present invention, that capacitance will be ignored. For the purpose of practical capacitance field solver tools, the adjacent touching shapes can be adjusted to be separated from the shape being analyzed by a small distance 252 which can be made as small as necessary to achieve the desired accuracy. This analysis holds for any spatially dependent dielectric ∈(r) which does not depend on the potential. It should be understood that not all such field solver tools are capable of working with touching shapes or shapes spaced by very small distances and thus would be inappropriate for use here.

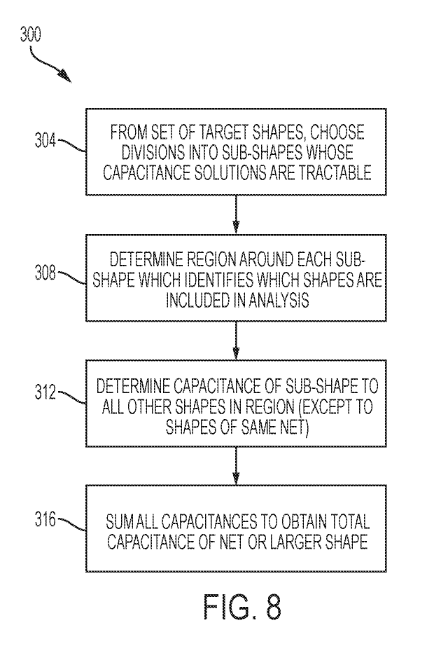

A method 300 according to an embodiment of the present invention is illustrated in the flow diagram of FIG. 8. In a step 304, from the set of target shapes, choose divisions or partitions of the target shapes into sub-shapes (e.g., shapes A 220 and B 224 in FIG. 6) whose capacitance extraction solutions are tractable (i.e., easily manageable or controlled). In a step 308, determine the region (e.g., region 212 in FIG. 5) around each such sub-shape which will identify which shapes should be included in the analysis of the capacitance of the sub-shape. If increased accuracy is desired, this region can be made bigger.

Then, in a step 312, determine the capacitance of the sub-shape to all other shapes in the region except to shapes of the same net. This is typically done by setting the target sub-shape to 1 volt and determining the charges on the other shapes in the region by solving Poisson's equation. Next, in a step 316, sum all capacitances determined in the previous step to get the total capacitance of the net or larger shape as desired.

The problem can be made tractable by choosing the sub-shapes to be sufficiently small in size. The solution can be made as accurate as desired by increasing the size of the region used to define the shapes to be included in the capacitive analysis.

Extraction performance in a field solver is a function of the number of shape interactions that the field solver must calculate the capacitances for. Reduced complexity can also reduce the complexity of the computation and can even decrease error.

The method 300 of an embodiment of the present invention illustrated in the flow diagram of FIG. 8 may achieve a speedup of approximately 50%, combined with an improvement in accuracy that avoids an approximate 10% loss with known solutions. This is because, in part, known solutions do a relatively poor job of setting up the field solver problem to account for end effects. Specifically, when partitions get smaller, more error is encountered by the known solutions.

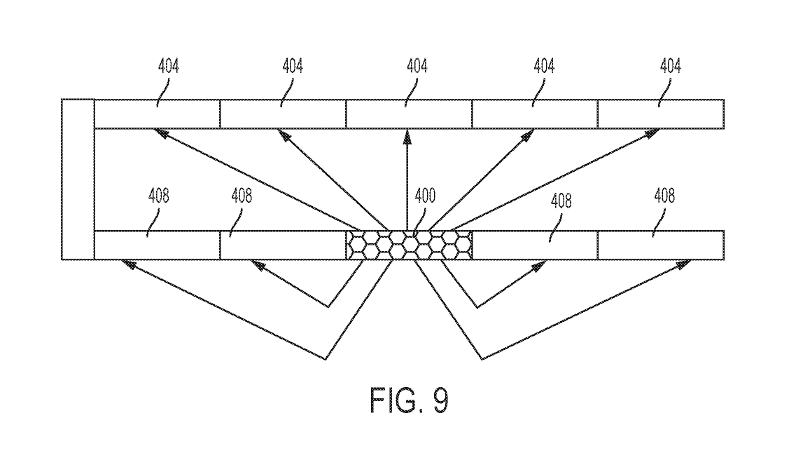

Referring to FIG. 9, there illustrated is another embodiment of the present invention which accounts for self-coupling. The method 300 of the flow diagram of FIG. 8 ignores any capacitive coupling from a net to itself which is normally acceptable. If situations, such as serpentine wiring, require accurate self-net capacitance, then a refinement to the method 300 of the flow diagram of FIG. 8 may be implemented in embodiments of the present invention. These refinements may identify such serpentine wiring shapes and may not ignore the extracted capacitance to those shapes such as shown in FIG. 9.

For example, for the sub-shape 400 shown as part of the serpentine interconnect circuit arrangement shown in FIG. 9, the capacitances that are extracted for the sub-shapes 404 that are not adjacent to the sub-shape 400 (i.e., that are in the next row over) may not be ignored and may be included in the total capacitance that is determined for the overall serpentine interconnect shape. On the other hand, the capacitances that are extracted for the sub-shapes 404 that are adjacent to the sub-shape 400 may be ignored and may not be included in the total capacitance that is determined for the overall serpentine interconnect shape.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
identifying an overall shape as part of a design of circuitry of an integrated circuit or a semiconductor chip;
partitioning the overall shape into a plurality of sub-shapes;
performing a capacitance extraction for each sub-shape, the capacitance extraction being performed for each sub-shape and at least one portion of at least one adjacent sub-shape; and
combining the determined amount of capacitance for each sub-shape into a total determined amount of capacitance for the overall shape;
wherein the performing a capacitance extraction determines an amount of capacitance for each sub-shape;
wherein the performing a capacitance extraction comprises applying a potential having a first voltage value to the sub-shape and applying a potential having a second voltage value to all other sub-shapes; and
wherein applying a potential having a first voltage value to the sub-shape and applying a potential having a second voltage value to all other sub-shapes induces an amount of electrical charge to be formed on the sub-shape.

2. The method of claim 1 wherein the circuitry of an integrated circuit comprises interconnect circuitry.

3. The method of claim 1 wherein the performing a capacitance extraction comprises performing a field solver analysis.

4. (canceled)

5. The method of claim 1 further comprising determining the amount of electrical charge formed on the sub-shape using Poisson's equation.

6. The method of claim 1 wherein the at least one portion of at least one adjacent sub-shape is selected based on a physical feature of the at least one portion of at least one adjacent sub-shape.

7. The method of claim 6 wherein the physical feature is a serpentine shape.

8. A system comprising:
a processor in communication with one or more types of memory, the processor configured to:
identify an overall shape as part of a design of circuitry of an integrated circuit or a semiconductor chip;
partition the overall shape into a plurality of sub-shapes;
perform a capacitance extraction for each sub-shape, the capacitance extraction being performed for each sub-shape and at least one portion of at least one adjacent sub-shape; and
combine the determined amount of capacitance for each sub-shape into a total determined amount of capacitance for the overall shape;
wherein the processor is configured to perform a capacitance extraction by determining an amount of capacitance for each sub-shape;
wherein the processor is configured to apply a potential having a first voltage value to the sub-shape and to apply a potential having a second voltage value to all other sub-shapes; and
wherein the processor being configured to apply a potential having a first voltage value to the sub-shape and to apply a potential having a second voltage value to all other sub-shapes induces an amount of electrical charge to be formed on the sub-shape.

9. The system of claim 8 wherein the circuitry of an integrated circuit comprises interconnect circuitry.

10. The system of claim 8 wherein the processor being configured to perform a capacitance extraction comprises the processor being configured to perform a field solver analysis.

11. (canceled)

12. The system of claim 8 the processor being further configured to determine the amount of electrical charge formed on the sub-shape using Poisson's equation.

13. The system of claim 8 wherein the at least one portion of at least one adjacent sub-shape is selected by the processor based on a physical feature of the at least one portion of at least one adjacent sub-shape.

14. The system of claim 13 wherein the physical feature is a serpentine shape.

15. A computer program product comprising:
a non-transitory storage medium readable by a processing circuit and storing instructions for execution by the processing circuit for performing a method comprising:
identifying an overall shape as part of a design of circuitry of an integrated circuit or a semiconductor chip;
partitioning the overall shape into a plurality of sub-shapes;
performing a capacitance extraction for each sub-shape, the capacitance extraction being performed for each sub-shape and at least one portion of at least one adjacent sub-shape; and
combining the determined amount of capacitance for each sub-shape into a total amount of capacitance for the overall shape;
wherein the performing a capacitance extraction determines an amount of capacitance for each sub-shape
wherein the performing a capacitance extraction comprises applying a potential having a first voltage value to the sub-shape and applying a potential having a second voltage value to all other sub-shapes; and
wherein applying a potential having a first voltage value to the sub-shape and applying a potential having a second voltage value to all other sub-shapes induces an amount of electrical charge to be formed on the sub-shape.

16. The computer program product of claim 15 wherein the circuitry of an integrated circuit comprises interconnect circuitry.

17. The computer program product of claim 15 wherein the performing a capacitance extraction comprises performing a field solver analysis.

18. (canceled)

19. The computer program product of claim 15 further comprising determining the amount of electrical charge formed on the sub-shape using Poisson's equation.

20. The computer program product of claim 15 wherein the at least one portion of at least one adjacent sub-shape is selected based on a physical feature of the at least one portion of at least one adjacent sub-shape, and wherein the physical feature is a serpentine shape.
